(19) United States
(12) Patent Application Publication
(10) Pub. No.: US 2012/0103498 A1
(43) Pub. Date: May 3, 2012

(54) TIRE CONTAINING A HEAT AND FLAME RESISTANT FIBROUS BARRIER LAYER AND METHOD FOR PROTECTING A TIRE

(75) Inventors: MARK ALLAN LAMONTIA, LANDENBERG, PA (US); WILLIAM HERBERT COULTER, WILMINGTON, DE (US); DERYA GULSEN ONBILGER, MIDLOTHIAN, VA (US)

(73) Assignee: E.I. DU PONT DE NEMOURS AND COMPANY, Wilmington, DE (US)

(21) Appl. No.: 12/913,018

(22) Filed: Oct. 27, 2010

(51) Int. Cl. B60C 9/02

(52) U.S. Cl. 152/548

(57) ABSTRACT

A pneumatic tire comprising at least one heat and flame resistant non-structural barrier layer of polymeric yarns, the barrier layer being positioned outward of the tire carcass cords in the crown and sidewall sections of the tire wherein the barrier layer extends from a point above the bead of the tire but below the flange of the outward rim of the wheel across the crown to the corresponding point on the inward rim of the wheel, wherein the barrier layer also extends in a circumferential direction around the tire and comprises yarns of aromatic polyamide, flame retardant nylon, flame retardant polyester or mixtures thereof.

### BACKGROUND

1. Field of the Invention

This invention pertains to a non-load bearing flame and heat resistant fibrous barrier layer suitable for use in vehicle tires.

2. Description of Related Art

Emergency response and military vehicles may suddenly be subjected to very high extremes of fire and/or heat. Under such circumstances, the tire structural integrity is frequently impaired and the vehicle cannot retreat to a safe distance. There is, therefore, a need to provide additional flame and heat resistance to enable tires to retain sufficient structural strength to permit a vehicle to escape from the heat and fire source.

United States Patent Application 2007/0251627 to Wright discloses a pneumatic tire including a floating reinforcing layer disposed between a body ply and the sidewall of the tire. The reinforcing layer may extend from a point beneath the rim flange to a point just above or below the maximum section width of the tire. By adding stiffness to the sidewall region at and above the rim, the reinforcing layer enhances the tire durability without sacrificing ride comfort.

United States Patent Application 2010/010822 to Lamontia et al relates to cut-resistant tire side-wall components comprising at least a single layer of knitted textile fabric providing multi-directional cut resistance.

### SUMMARY OF THE INVENTION

This invention pertains to a pneumatic tire comprising at least one heat and flame resistant non-structural barrier layer of polymeric yarns, the barrier layer being positioned outward of the tire carcass cords in the crown and sidewall sections of the tire wherein
(i) the barrier layer extends from a point above the bead of the tire but below the flange of the outward rim of the wheel across the crown to the corresponding point on the inward rim of the wheel,
(ii) the barrier layer extends in a circumferential direction around the tire,
(iii) the barrier layer has an open area of from 18 to 65 percent,
(iv) the polymer for the yarns of the barrier layer is aromatic polyamide, flame retardant nylon, flame retardant polyester or mixtures thereof, and
(v) the yarns of the barrier layer are in the form of cords.

The invention also pertains to a method for protecting structural cords in a tire from heat or flame comprising interposing, in the tire, between the structural cords and the source of heat at least one heat and flame resistant non-structural barrier layer of polymeric yarns

### BRIEF DESCRIPTION OF THE DRAWINGS

FIG. 1 shows a cross-section of a vehicle tire.

FIG. 2 shows a cross-section of a vehicle tire comprising one piece of fire barrier layer.

FIG. 3 shows a cross-section of a vehicle tire comprising two pieces of fire barrier layer.

FIG. 4 shows a cross-section of a vehicle tire comprising four pieces of fire barrier layer.

FIG. 5 shows a cross-section of a vehicle tire comprising three pieces of fire barrier layer.

FIG. 6 shows a cross-section of a vehicle tire comprising three pieces of fire barrier layer.

FIG. 7 shows a cross-section of a vehicle tire comprising four pieces of fire barrier layer.

### DETAILED DESCRIPTION

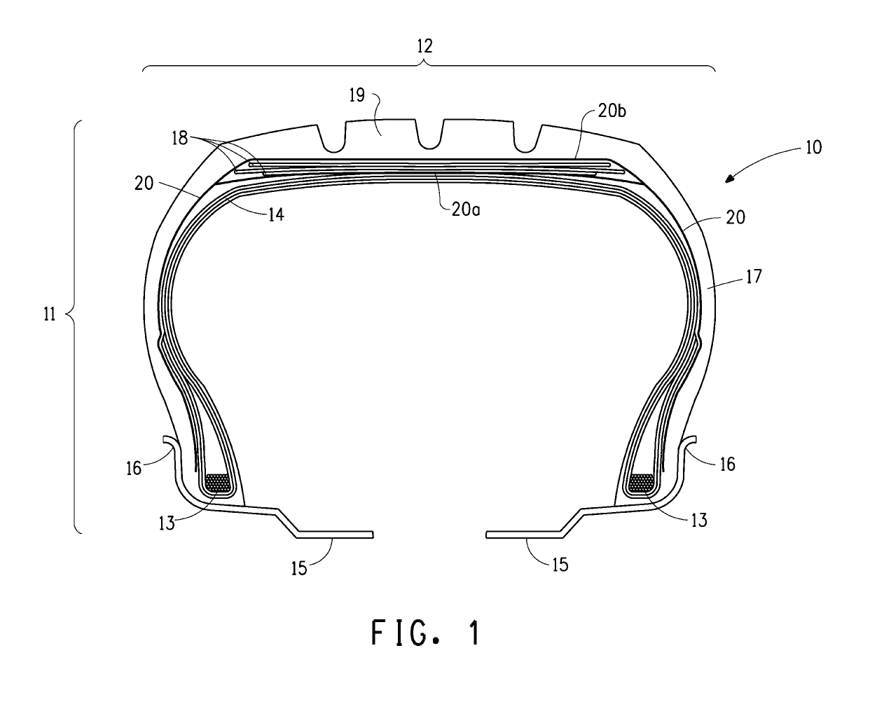

Shown generally at 10 in FIG. 1 is a cross-section of an automobile or truck tire comprising two principal sections, a sidewall section 11 and a crown section 12. A tire sidewall is the area between the tire bead and the tread. “Crown” means that portion of the tire within the width limits of the tire tread. Beads 13 are located where the tire sits on the rim flange. “Bead” means that part of the tire comprising an annular tensile member wrapped by ply cords and shaped, with or without other reinforcement elements such as flippers, chippers, apexes, toe guards and chafers, to fit the wheel rim. Carcass cords 14 provide strength and load bearing capabilities to the tire. “Carcass” means the tire structure apart from the belt structure, tread, undertread, and sidewall rubber over the plies, but including the beads. A carcass is sometimes called a casing. The carcass cords are anchored by wrapping them around the bead wires 13. Also shown in FIG. 1 are wheel rims 15. When assembled on the vehicle axle, the outward wheel rim is further away from the car body and the inward wheel rim is closer to the car body. The rims have flanges 16. “Tread” means that portion of a tire that comes into contact with the road when the tire is normally inflated and under normal load. A “belt” is a narrow layer of tire cord material directly under the tread in the crown of the tire. In truck tires, sometimes belts are called breakers. A heat and flame resistant non-structural barrier layer, hereinafter “barrier layer,” is shown at 20 and extends across the tire from a point above the tire bead 13, but below the flange 16 of the outward rim of the wheel across the crown to the corresponding point on the inward rim of the wheel. In the tire sidewall section, the barrier layer is positioned between the carcass ply cords 14 and the sidewall rubber layer 17. In the tire crown section, the barrier layer is positioned either between the outer facing surface of the tire carcass cords 14, and below the steel belt of the tire 18 as shown at 20a or, as in 20b, between the outer facing surface of the tire steel belt(s) 18 and below the tire treads 19. In some embodiments, barrier layers 20a and 20b may both be present.

The barrier layer may be a single piece (sheet) or a plurality of sheet sections placed next to each other. Preferably, adjacent sheets are joined by a butt joint or an overlap joint. In an overlap joint it does not matter which layers overlap the other. There may be small gaps between adjacent sheets especially at butt joints. The barrier layer may extend either partially or fully around the circumference of the tire.

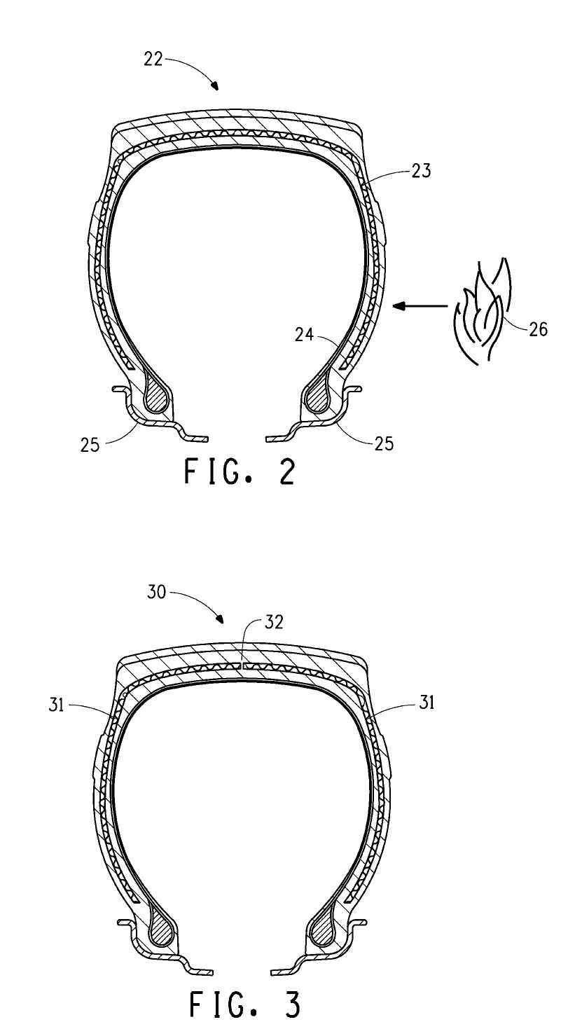

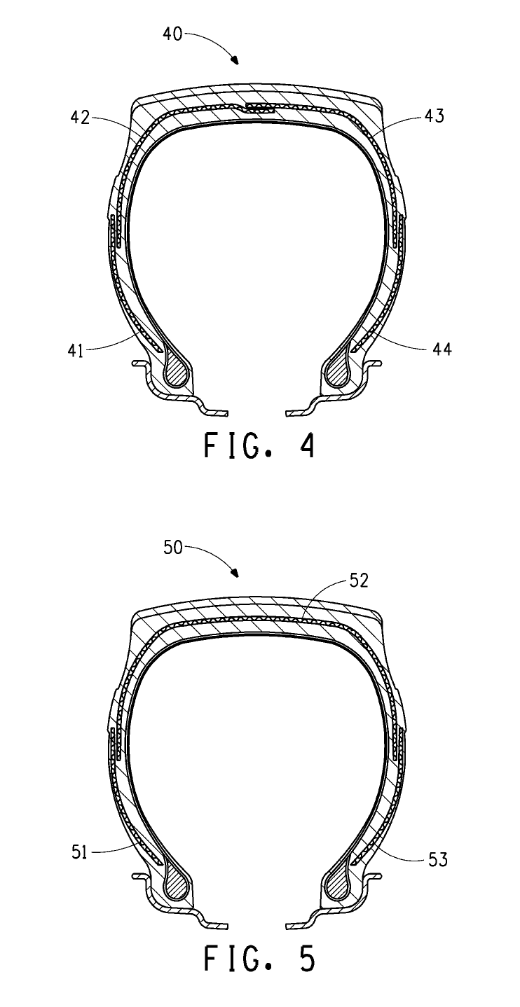

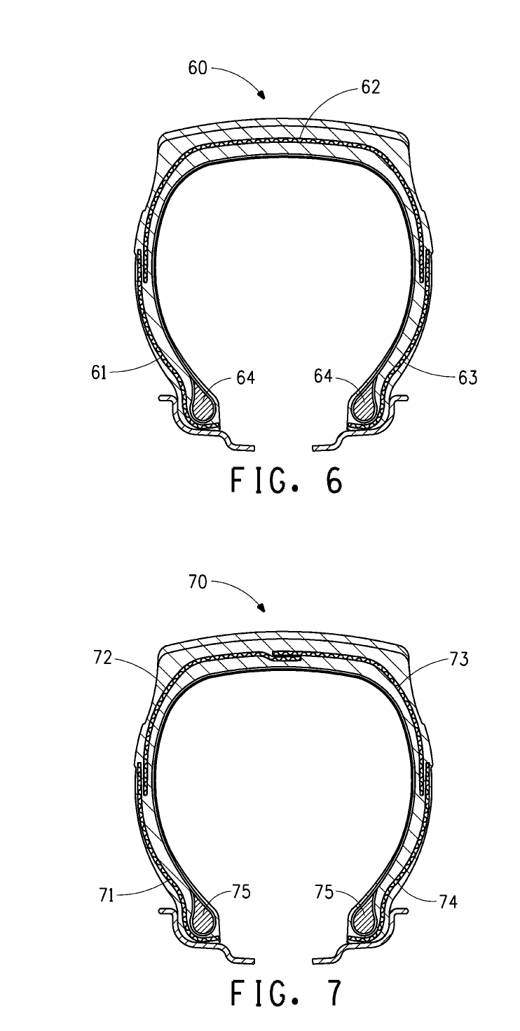

As shown at 22 in FIG. 2, one embodiment of the barrier layer comprises a single piece 23 extending across the tire from above one wheel rim 25 to above the other wheel rim 25. FIG. 3 depicts at 30 a barrier layer comprising two sections 31 that form a butt joint at the center of the crown section 32. FIG. 4 shows generally at 40 a barrier layer having four sections with adjacent sections overlapping each other. Section 41 overlaps one end of section 42, section 43 overlaps the other end of section 42 and section 44 overlaps section 43. FIG. 5 shows at 50 a barrier layer having three sections with adjacent sections 51 and 53 overlapping section 52. FIG. 6 shows at 60 a three section barrier layer in which layers 61 and 63 wrap underneath the beads 64. FIG. 7 shows at 70 a four section barrier layer in which layers 71 and 74 wrap underneath the beads 75 beginning and ending layer wrapping the bead. Layers 71 and 73 also wrap over layer 72. Layer 74 also wraps over layer 73. In some embodiments, the barrier layer may also be sectioned into a plurality of sheets running in the circumferential direction of the tire. The orientation of the yarns comprising the barrier layer may be in any direction.

By positioning the barrier layer 23 of FIG. 2 between the structural carcass cords 24 and the external source of heat and/or fire 26, the barrier layer provides additional heat and fire protection to the structural carcass cords. A similar rationale applies to the other figures. This permits the structural cords to function for a longer period when in a hazardous environment.

The barrier layer may be one ply thick or there may be a plurality of plies stacked one on top of each other. FIGS. 1 to 7 show a single ply layer.

In one embodiment, the barrier layer has a free area of from 18 to 65 percent. “Free area” is a measure of barrier layer openness and is the amount of area in the barrier layer plane that is not covered by yarns. Free area is determined by taking an electronic image of the light from a light table passing through a six-inch by six-inch square fabric sample and comparing the intensity of the measured light to the intensity of white pixels. In some embodiments the barrier layer has a free area of from 25 to 65 percent and in other embodiments 30 to 65 percent, while in yet another embodiment the free area of the barrier layer is from 40 to 65 percent. This openness of the barrier layer provides adequate space for the tire rubber to fully impregnate through the barrier layer during the tire molding process.

In some embodiments, the barrier layer having a free area of from 18 to 65 percent has a coating for good barrier layer to rubber adhesion. After the coating is applied to the barrier layer, the resulting coated barrier layer retains a free area of from 18 to 65 percent. As in the barrier layer without coating, some embodiments the barrier layer after coating have a free area of from 25 to 65 percent and in other embodiments 30 to 65 percent, while in yet another embodiment the barrier layer after coating has a free area of from 40 to 65 percent. The coating is a polymeric material designed to increase the barrier layer adhesion to the rubber matrix. Generally, the coating is the same as can be used for dipped tire cords. The coating can be selected from epoxies, isocyanates, and various resorcinol-formaldehyde latex mixtures. In some embodiments, the coating material is an epoxy resin subcoat and a resorcinol-formaldehyde topcoat.

The barrier layer comprises polymeric yarns. For purposes herein, the term “filament” is defined as a relatively flexible, macroscopically homogeneous body having a high ratio of length to width across its cross-sectional area perpendicular to its length. The filament cross-section can be any shape, but is typically circular, oval or bean-shaped. The filaments may be formed into a yarn comprising a plurality of filaments. Multifilament yarn spun onto a bobbin in a package contains a plurality of continuous filaments. The multifilament yarn can be cut into staple fibers and made into a spun staple yarn suitable for use in the present invention. The staple fiber can have a length of about 0.4 to about 5 inches (about 1.0 cm to about 12.7 cm) or even of about 1.5 inches (3.8 cm) to 2.5 inches (6.3 cm). The staple fiber can be straight (i.e., non crimped) or crimped to have a saw tooth shaped crimp along its length, with a crimp (or repeating bend) frequency of about 3.5 to about 18 crimps per inch (about 1.4 to about 7.1 crimps per cm).

The filaments have a tenacity of at least 7.3 grams per dtex and a modulus of at least 100 grams per dtex. Preferably, the yarns have a linear density of 50 to 4500 dtex, a tenacity of 10 to 65 g/dtex, a modulus of 150 to 2700 g/dtex, and an elongation to break of 1 to 8 percent. More preferably, the yarns have a linear density of 100 to 3500 dtex, a tenacity of 15 to 50 g/dtex, a modulus of 200 to 2200 g/dtex, and an elongation to break of 1.5 to 5 percent.

The yarns can be intertwined and/or twisted. The yarns are formed into a cord or a fabric. A tire cord is a twisted or formed structure composed of two or more strands. Cords are well known in the tire construction industry. A cord may comprise one or more filaments. When a cord comprises a plurality of filaments, the filaments may be intertwined (helically wound) with each other. In some embodiments, the filaments are intertwined at a helical angle of from about four to forty degrees. In one embodiment, the cords in the fire barrier layer are aligned parallel to each other. The orientation direction is not critical as the cords do not provide structural reinforcement. The greater the number of cords per inch of barrier layer, the lower will be the free area of the layer. When the yarns are formed into a fabric, the fabric may be woven, may be a knit, may be unidirectional, or may be multiaxial. A “knitted” fabric is a fabric produced by interlooping one or more ends of yarn. The term “woven” is meant herein to be any biaxial fabric that can be made by weaving; that is, by interlacing or interweaving at least two yarns typically at right angles. Generally, such fabrics are made by interlacing one set of yarns called warp yarns with another set of yarns called weft or fill yarns. The woven fabric can have essentially any weave, such as, plain weave, crowfoot weave, basket weave, satin weave, twill weave, unbalanced weaves, and the like. An unbalanced weave has more yarns in one direction than the other. A unidirectional fabric is a fabric in which all the filaments or yarns are aligned in substantially the same direction. In a unidirectional fabric there may be an occasional yarn in a second direction to provide some stability or cohesiveness to the fabric. A binder may also be used to stabilize a unidirectional fabric. A binder resin typically comprises about 2 to 12% by weight based on the weight of the fabric. A multiaxial fabric is a fabric comprising a plurality of layers having different fiber orientation in each layer that are not woven. The layers are held together by stitching thorough the layers. These are also known as non-crimped fabrics. An example of a multiaxial fabric is one comprising four layers having fiber orientations of 0°/+45°/−45°/90° in the respective layers.

A mixture of yarns of different polymers may also be used to form the barrier layer.

The yarns comprise filaments that are either naturally flame retardant or rendered flame retardant by the addition of flame retardant additives. For synthetic fibers, such additives are typically added into the polymer prior to spinning. For natural fibers, the additives are coated onto the fiber surface. A fiber is generally deemed to be naturally flame retardant if it has a Limiting Oxygen Index (LOI) of 26 or greater without the addition of any flame retardant chemicals. LOI is the minimum oxygen concentration that will just support flaming combustion in a flowing mixture of oxygen and nitrogen and is measured by techniques such as specified in ASTM D2863. Naturally flame retardant fibers include anisotropic melt polyesters, poly(butylene terephthalate), poly(acrylonitrile butadiene styrene), polyvinylchloride, polysulfone, poly(ether-ether-ketone), poly(ether-ketone-ketone), polyethersulfone, polyarylate, polyphenylsulfone, polyetherimide, polyamide-imide, aromatic polyamide, flame retardant nylon, flame retardant polyester, flame retardant polyolefins and mixtures thereof. In some embodiments of this invention, flame retardant is added to the polymer in the amount of about 10 to 15 percent by weight of the polymer to achieve the desired LOI.

Flame retardant cellulose polymer may also be used to form the yarns.

In one embodiment aromatic polyamide is a preferred fiber polymer. Preferred aromatic polyamides are meta-aramid (m-aramid) and para-aramid (p-aramid).

The term “aramid” means a polyamide wherein at least 85% of the amide (—CONH—) linkages are attached directly to two aromatic rings. Suitable aramid fibers are described in Man-Made Fibres—Science and Technology, Volume 2, Section titled Fibre-Forming Aromatic Polyamides, page 297, W. Black et al., Interscience Publishers, 1968. Aramid fibers and their production are, also, disclosed in U.S. Pat. Nos. 3,767,756; 4,172,938; 3,869,429; 3,869,430; 3,819,587; 3,673,143; 3,354,127; and 3,094,511.

The preferred para-aramid is poly(p-phenylene terephthalamide) which is called PPD-T. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

Methods for making para-aramid fibers are generally disclosed in, for example, U.S. Pat. Nos. 3,869,430; 3,869,429; and 3,767,756. Such aromatic polyamide organic fibers and various forms of these fibers are available from E. I. du Pont de Nemours & Company, Wilmington, Del. (DuPont) under the tradename Kevlar® fibers and from Teijin Ltd. of Tokyo, Japan under the tradename Twaron® fibers. Technora® fiber, also available from Teijin is made from copoly(p-phenylene/3,4′diphenyl ester terephthalamide) and may also be considered a para-aramid fiber.

When the fiber is meta-aramid, meta-aramid fiber means meta-oriented synthetic aromatic polyamide polymers. The polymers can include polyamide homopolymers, copolymers, and mixtures thereof which are predominantly aromatic, wherein at least 85% of the amide (—CONH—) linkages are attached directly to two aromatic rings. The rings can be unsubstituted or substituted. The polymers are meta-aramid when the two rings or radicals are meta oriented with respect to each other along the molecular chain. Preferably copolymers have no more than 10 percent of other diamines substituted for a primary diamine used in forming the polymer or no more than 10 percent of other diacid chlorides substituted for a primary diacid chloride used in forming the polymer. Additives can be used with the aramid; and it has been found that up to as much as 13 percent by weight of other polymeric material can be blended or bonded with the aramid.

The preferred meta-aramids are poly(meta-phenylene isophthalamide)(MPD-I) and its copolymers. One such meta-aramid fiber is Nomex® aramid fiber available from DuPont, however, meta-aramid fibers are available in various styles under the trademarks Conex®, available from Teijin Ltd. of Tokyo, Japan; Apyeil®, available from Unitika, Ltd. of Osaka, Japan; New Star® meta-aramid, available from Yantai Spandex Co. Ltd, of Shandong Province, China; and Chinfunex® Aramid 1313 available from Guangdong Charming Chemical Co. Ltd., of Xinhui in Guangdong, China. Meta-aramid fibers are inherently flame resistant and can be spun by dry or wet spinning using any number of processes; however, U.S. Pat. Nos. 3,063,966; 3,227,793; 3,287,324; 3,414,645; and 5,667,743 are illustrative of useful methods for making aramid fibers that could be used.

By nylon it is meant fibers made from aliphatic polyamide polymers. Such polymers include polyhexamethylene adipamide (nylon 66), polycaprolactam (nylon 6), polybutyrolactam (nylon 4), poly(9-aminononanoic acid) (nylon 9), polyenantholactam (nylon 7), polycapryllactam (nylon 8), polyhexamethylene sebacamide (nylon 6, 10), and the like. It is known that the fire retardancy of some nylon compositions may be enhanced by the incorporation therein of various chlorinated organic fire retardants, often in combination with a suitable metal oxide, such as a zinc, iron or antimony oxide. A particularly effective fire retardant for Nylon 6 and Nylon 66 is bis(hexachlorocyclopentadieno)cyclooctane. The incorporation of bis(hexachlorocyclopentadieno)cyclooctane, optionally in combination with a suitable metal oxide, in nylon compositions, is disclosed in U.S. Pat. No. 3,403,036 to Hindersinn et al. It is known that such nylon compositions are characterized by excellent fire retardant properties and are generally satisfactory to excellent with respect to most of the desired physical properties sought in nylon compositions.

In some embodiments, a preferred flame retardant polyester polymer is flame retardant polyethylene terephthalate (FR PET) or flame retardant polyethylene naphthalate (FR PEN). These polymers may include a variety of comonomers, including diethylene glycol, cyclohexanedimethanol, poly(ethylene glycol), glutaric acid, azelaic acid, sebacic acid, isophthalic acid, and the like. In addition to these comonomers, branching agents like trimesic acid, pyromellitic acid, trimethylolpropane and trimethyloloethane, and pentaerythritol may be used. The FR PET may be obtained by known polymerization techniques from either terephthalic acid or its lower alkyl esters (e.g. dimethyl terephthalate) and ethylene glycol or blends or mixtures of these. FR PEN may be obtained by known polymerization techniques from 2,6-naphthalene dicarboxylic acid and ethylene glycol. Representative types of FR additives include such things as 8% octa-bromo diphenyl and 4% antiomony trioxide.

In other embodiments, the preferred polyesters used are liquid crystalline polyesters that are naturally flame retardant. By a “liquid crystalline polyester” (LCP) herein is meant a polyester polymer that is anisotropic when tested using the TOT test or any reasonable variation thereof, as described in U.S. Pat. No. 4,118,372, which is hereby included by reference. One preferred form of LCP is “all aromatic”, that is all of the groups in the polymer main chain are aromatic (except for the linking groups such as ester groups), but side groups that are not aromatic may be present. LCP useful as thermoplastic material in this invention has melting point up to 350° C. Melting points are measured per test method ASTM D3418. Melting points are taken as the maximum of the melting endotherm, and are measured on the second heat at a heating rate of 10° C./min. If more than one melting point is present the melting point of the polymer is taken as the highest of the melting points. A preferred LCP for this invention include corresponding grades of Zenite® available from DuPont and Vectra® LCP available from Ticona Co.

### Test Methods

Residual strength following exposure to flame is a useful measure to assess the potential of materials to provide effective thermal barriers for tires. To assess residual strength, the break strength of samples comprising barrier layers were assessed prior to exposure to flame and compared with the break strength of similar laminates following flame exposure times of 5, 10, 30 and 60 seconds.

Laminate sheets 12 inches wide, 12 inches long by 0.08 inches thick were used for thermal exposure. Each laminate consisted of either 18 or 28 tire cords per inch covered with standard tire rubber compound. No flame resistant materials were added to the compound. Thermal exposure of the laminate sheet was conducted on a thermal burner that provided a uniform flame front across the exposed surface of the sample. The burner unit consisted of a mixing plenum, a 16 in² burner designed to produce uniform heat flux across the entire surface area, ignition source, flame sensor and a shutter to control sample exposure. For the above tests, an air to fuel ratio of 14 to 1 and air flow of 4 standard liters per minute were used. The fuel source was propane. These settings developed a flame temperature of 1100° C. on the backside of the laminate sheet.

After exposure to flame, the laminates were separated into tensile strips 0.75 inches wide by 12 inches long. The samples were tabbed with cardboard tabs to assure samples did not slip during testing. The samples were tested in accordance with ISO 527-5, 1997 “Plastics—Determination of Tensile Properties—Part 5: Test Conditions for Unidirectional Fibre-reinforced Plastic Composites” to determine break strength. Following testing, the break strength was normalized for the number of cords found in the sample. This provided strength on a per cord basis. This procedure was repeated three times for each exposure condition and the results were averaged to determine the break strength for each condition.

### EXAMPLES

Examples prepared according to the current invention are indicated by numerical values. Control or Comparative Examples are indicated by letters.

### Example A

Example A was a layer comprising cords made with two plies of 1260 denier polyamide 6,6 yarn. Each ply had 10s twist and the plies were twisted together with 10z to form a cord. The cord was dipped in a resorcinol-latex coating to promote rubber to cord adhesion. A barrier layer was made by assembling a sheet comprising 18 dipped cords per inch per inch of barrier layer. The sheet was cut into five 3048 mm square test samples. The weight of each 3048 mm×3048 mm sheet was 200 grams. One sample was not exposed to flame. The remaining samples were exposed to flame for 5, 10, 30 and 60 seconds respectively. During the 60 second exposure, the test sample burned through, so no residual strength measurements could be performed. The remaining exposed samples were tested for mechanical strength and the data analyzed. The polyamide 6,6 cord barrier layer quickly lost strength with exposure to flame. After 10 seconds the layer retained only 50% of its original strength, after 30 seconds only 15%, and shortly after the 30 seconds the layer succumbed to the flames and burned.

### Example 1

Example 1 was a layer comprising cords made with two plies of 1500 denier Kevlar® K119 para-aramid yarn available from E.I. DuPont de Nemours and Company, Wilmington, Del. Each ply had 8.7s twist and the plies were twisted together with 8.7z twist to form the cord. The cord was dipped in a resorcinol-latex coating to promote rubber to cord adhesion. A barrier layer was made by assembling a sheet comprising 28 dipped cords per inch per inch of barrier layer. The sheet was cut into five 3048 mm square test samples. The weight of the each sheet was 202 grams. One sample was not exposed to flame. The remaining samples were exposed to flame for 5, 10, 30 and 60 seconds respectively. After exposure to flame, the mechanical strength tests were carried out on all the samples. Even after 60 seconds of exposure, of the barrier layer comprising Kevlar® K119 yarn cords retained 90% of original break strength.

Comparison of the test results show that a barrier layer comprising aromatic polyamide (para-aramid) yarn provides satisfactory flame resistance while a barrier layer comprising polyamide 6,6 does not. Barrier layer examples fabricated from flame retardant nylon or flame retardant polyester are also expected to provide satisfactory flame resistance.

1. A pneumatic tire comprising at least one heat-resistant, flame resistant, non-structural barrier layer of polymeric yarns, the barrier layer being positioned outward of the tire carcass cords in the crown and sidewall sections of the tire wherein
(i) the barrier layer extends from a point above the bead of the tire but below the flange of the outward rim of the wheel across the crown to the corresponding point on the inward rim of the wheel,
(ii) the barrier layer extends in a circumferential direction around the tire,
(iii) the barrier layer has an open area of from 18 to 65 percent,
(iv) the polymer for the yarns of the barrier layer is aromatic polyamide, flame retardant nylon, flame retardant polyester or mixtures thereof, and
(v) the yarns of the barrier layer are in the form of cords.

2. The tire of claim 1, wherein, in the sidewall section, the barrier layer is positioned between the sidewall rubber layer and the ply cords.

3. The tire of claim 1, wherein, in the crown section, the barrier layer is positioned between the outer facing surface of the tire carcass cords and below the steel belt of the tire.

4. The tire of claim 1, wherein, in the crown section, the barrier layer is positioned between the outer facing surface of the steel belt of the tire and below the tire treads.

5. The tire of claim 1, wherein the barrier layer is formed from one piece.

6. The tire of claim 1, wherein the barrier layer comprises a plurality of sections.

7. The tire of claim 1, wherein the polymeric yarns are aromatic polyamide.

8. The tire of claim 7, wherein the aromatic polyamide is m-aramid or p-aramid.

9. A method for protecting structural cords in a tire from heat or flame comprising interposing, in the tire, between the structural cords and the source of heat at least one heat-resistant, flame-resistant, non-structural barrier layer of polymeric yarns, wherein
(i) the barrier layer extends from a point above the bead of the tire but below the flange of the outward rim of the wheel across the crown to the corresponding point on the inward rim of the wheel,
(ii) the barrier layer extends in a circumferential direction around the tire,
(iii) the barrier layer has an open area of from 18 to 65 percent,
(iv) the polymer for the yarns of the barrier layer is aromatic polyamide, flame retardant nylon, flame retardant polyester or mixtures thereof, and
(v) the yarns of the barrier layer are in the form of cords.

10. The method of claim 9, wherein, in the sidewall section, the barrier layer is positioned between the sidewall rubber layer and the ply cords.

11. The method of claim 9, wherein, in the crown section, the barrier layer is positioned between the outer facing surface of the tire carcass cords and below the steel belt of the tire.

12. The method of claim 9, wherein, in the crown section, the barrier layer is positioned between the outer facing surface of the steel belt of the tire and below the tire treads.

13. The method of claim 9, wherein the barrier layer comprises a plurality of sections.

14. The method of claim 9, wherein the polymeric yarns are aromatic polyamide.

15. The method of claim 14, wherein the aromatic polyamide is m-aramid or p-aramid.
